(19) United States
(12) Patent Application Publication
(10) Pub. No.: US 2003/0051153 A1
(43) Pub. Date: Mar. 13, 2003

(54) Device for reading, recording and restoring digital data in a copy-protection system for said data

(76) Inventors: Jean-Pierre Andreaux, Rennes (FR); Sylvain Chevreau, Rennes (FR); Eric Diehl, Liffre (FR); teddy Furon, Rennes (FR)

Correspondence Address: Thomson Multimedia Licensing, Patent Operation, PO Box 5312, Princeton, NJ, 08543, US

(21) Appl. No.: 10/221,968

(22) PCT Filed: Feb. 28, 2001
(86) PCT No.: PCT/FR01/00572

(30) Foreign Application Priority Data
Mar. 31, 2000 (FR) 00/04222

(51) Int. Cl. H04L 9/00

(52) U.S. Cl. 713/200; 713/189

(57) ABSTRACT

The invention concerns a device for reading digital data (10) receiving data representing a content designed to be connected to a digital home network. It comprises: first means for encrypting (13) data in accordance with a protection mode specific to a line whereby the device is to be connected to another digital network device, the encrypted data being in that case supplied to a first output (S1); and second means for encrypting (14) data in accordance with a mode specific to the home network, the encrypted data being in that case supplied to a second output (S2). The invention also concerns a device for recording and restoring digital data designed to be connected to said reading device (10).

### FIELD OF THE INVENTION

The invention relates generally to the field of protection against the copying of digital data, more especially within a digital home network environment.

### BACKGROUND ART

A digital home network can convey digital data emanating from various sources external to the network. This may involve data stored on detachable media such as optical discs, for example DVD discs (standing for “Digital Versatile Disc”), or magnetic tapes, the media being either prerecorded, or recordable.

This may also involve data which is broadcast and then injected onto the digital home network, for example digital television signals broadcast by satellite, by cable or by digital networks over the airwaves. The data may also be downloaded from the Internet.

Finally, a digital home network may moreover be called upon to manage digital data stored locally, for example in a hard disk linked to the home network.

These digital data may be separated into two main categories: on the one hand the data which do not require particular protection (for example, that pertaining to a personal creation of the user of the home network) and on the other hand the data which have to be protected against copying so as to safeguard the interests of their creator (film, music, games, etc.).

Various mechanisms and possibilities currently exist for protecting digital data against illegitimate copying.

The two principal techniques of protection are currently:

the encryption of the data which consists in transforming intelligible (or “plaintext”) data into encrypted or scrambled data with the aid of a key, this key being either a secret key shared by the device which encrypts the data and by that which is authorized to decrypt them, or in asymmetric cryptography systems a private or public key;

the watermarking of the data, which consists in inserting in an imperceptible manner a watermark attached to the data to be protected. The watermark must be nonmodifiable and nonerasable even in the event of transformation of the data to be protected.

The two techniques above may naturally be associated by combining the watermarking and encryption of the data.

Moreover, the digital data broadcast are usually protected within the framework of a conditional access system. In this type of system, the data supplied by various service providers are transmitted in a form scrambled by control words CW so as to guarantee that the data reach only those users who have acquired the right to receive them (for example through a subscription to the service). The control words are themselves transmitted in the data stream broadcast after having been encrypted with an algorithm with key K, this key K being contained in a secure processor, for example included in a smart card, which is supplied to the users by the service provider so as to allow them to decrypt the control words and hence to descramble the data.

In digital home networks, two main methods have been proposed hitherto for using and combining these protection techniques:

the first method consists in protecting the data which require protection by encrypting/scrambling them locally from one end to the other of the network (one generally speaks of “end-to-end protection”), that is to say from the moment they enter at a point of the network until the time they are restored to the user (video display on a television screen, broadcasting of music by a loudspeaker, etc.), all the apparatus of the network using the same type of protection, specific to the home network. The data are therefore never available as plaintext in the network, whether this be on the digital bus interlinking the apparatus or in the apparatus themselves, except at the eventual moment of their restoration, generally in analogue form, to the user;

the second method consists in associating a protection which is local to each type of apparatus of the network (a particular encryption type, a conditional access system, etc.) with a “line” protection (or “point-to-point” protection); in this type of method, the data are available as plaintext inside the apparatus but are never available as plaintext on the digital bus interlinking the various apparatus of the network; the data are in fact reencrypted before being transmitted on the bus.

### SUMMARY OF THE INVENTION

An aim or the present invention is to propose a system making it possible to conciliate the various methods of protection which have been proposed hitherto.

The invention therefore relates to a device for reading digital data which is intended to be connected to a digital home network and is capable of receiving data representing a content. The latter comprises according to the invention:

a first means for encrypting the data according to a protection mode specific to a line with which the device is intended to be connected to another device of the digital network, the encrypted data being in this case supplied to a first output; and

a second means for encrypting the data according to a protection mode specific to the home network, the encrypted data being in this case supplied to a second output.

According to an advantageous characteristic of the invention, the device further comprises a decision module adapted for delivering a permission or a prohibition to copy and/or to read the digital data, said digital data being supplied to the first or the second means for encrypting when the decision module delivers a copy prohibition or a single-copy permission.

According to another advantageous characteristic of the invention, the digital data are supplied directly to the first and/or to the second output without being encrypted when the decision module delivers an unlimited copy permission.

According to another particular characteristic of the invention, the device does not supply any digital data to the first or to the second output when the decision module delivers a read prohibition.

According to another particular characteristic of the invention, the decision module delivers an unlimited copy permission when the digital data received are not encrypted.

According to a preferred characteristic of the invention, the decision module delivers an unlimited copy permission when moreover the digital data received are not watermarked.

According to another particular characteristic of the invention, the decision module delivers a read prohibition when the digital data received are not encrypted and are watermarked.

According to another particular characteristic of the invention, the decision module delivers a copy prohibition when the digital data received are encrypted; and said digital data received are stored on a medium of recordable type; and copy control information contained in said data indicate that a single copy is authorized.

According to another particular characteristic of the invention, the decision module delivers a read prohibition when the digital data received are encrypted; and said digital data received are stored on a medium of recordable type; and copy control information contained in said data indicate that no copy is authorized.

According to another particular characteristic of the invention, the decision module delivers a single-copy permission when the digital data received are encrypted; and said digital data received are stored on a medium of nonrecordable type or are data broadcast or downloaded; and copy control information contained in said data indicate that a single copy is authorized.

According to another particular characteristic of the invention, the decision module delivers a copy prohibition when the digital data received are encrypted; and said digital data received are stored on a medium of nonrecordable type or are data broadcast or downloaded; and copy control information contained in said data indicate that no copy is authorized.

According to yet another advantageous characteristic of the invention, the information regarding permission or prohibition to copy and/or to read the digital data delivered by the decision module is attached to the data supplied to the first or to the second output.

According to a particular embodiment of the invention, the first and the second output are linked respectively to a single plug for connecting the device to a digital bus of the home network, said bus operating in a first protected mode when the data emanate from the first output and in a second nonprotected mode when the data emanate from the second output.

Advantageously, the choice of the first or of the second output to supply the data is determined by the device connected to the digital home network intended to receive the data transmitted by the reading device on the home network.

The invention also relates to a device for recording digital data which is intended to be connected to a reading device such as described above by way of a digital home network. According to the invention, this recording device comprises:

a first input intended for receiving data which have been supplied to the first output of the reading device; and

a second input intended for receiving data which have been supplied to the second output of the reading device.

According to a particular characteristic of the invention, the recording device comprises a means for decrypting the data according to a protection mode specific to a line with which the device is intended to be connected to the reading device, said means for decrypting being linked to the first input of the recording device.

According to another particular characteristic of the invention, the recording device furthermore comprises a decision module adapted for analysing the copy and/or read permission or prohibition information attached to the data to be recorded. The recording device delivers the data to be recorded to an output when the decision module detects a copy permission. On the other hand, the recording device deliver no data item to be recorded to the output when the decision module detects a copy prohibition.

The invention also relates to a device for restoring digital data which is intended to be connected to a reading device such as described above by way of a digital home network. According to the invention, this device comprises:

a first input intended to receive data which have been supplied to the first output of the reading device and which is linked to a first means for decrypting the data according to a protection mode specific to a line with which the device is intended to be connected to the reading device; and

a second input intended to receive data which have been supplied to the second output of the reading device and which is linked to a second means for decrypting the data according to a protection mode specific to the home network.

### BRIEF DESCRIPTION OF THE DRAWINGS

The invention will be better understood on reading the following description, of a nonlimiting embodiment thereof given with reference to the appended drawings in which:

FIG. 1 represents a digital home network illustrating the principle of the invention;

FIG. 2 represents a device for reading digital data according to the invention which is intended to be connected to a home network;

FIG. 3 represents a device for recording digital data according to the invention which is intended to be connected to a home network;

FIG. 4 represents a device for restoring digital data which is intended to be connected to a home network;

FIG. 5 illustrates a process implemented in the device of FIG. 2; and

FIG. 6 illustrates a process implemented in the device of FIG. 3.

### DETAILED DESCRIPTION OF THE EMBODIMENTS OF THE INVENTION

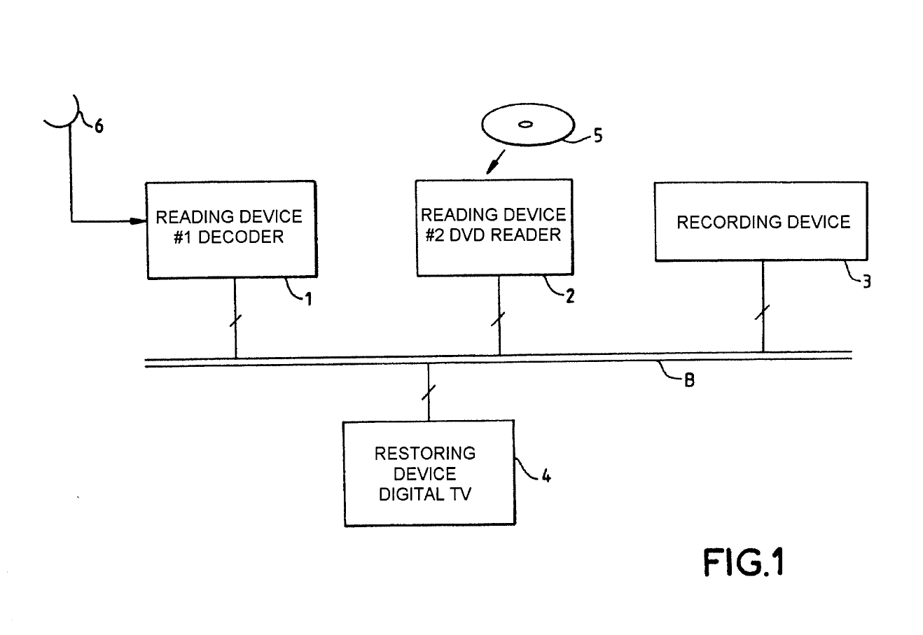

Represented in FIG. 1 is an example of a digital home network. The latter is composed of a certain number of devices interlinked by a digital bus B, for example a bus according to the IEEE 1394 Standard. These devices may be divided into three categories:

reading devices which are capable of receiving digital data originating from various sources of data; in FIG. 1, two examples of these devices are represented: the decoder 1 receiving data from a satellite antenna 6, in particular digital television programmes, and the DVD reader 2 capable of reading DVD discs 5;

data recording devices, such as the device 3, which are capable of recording the content of the data read by the reading devices on permanent recording media; and

restoring devices, such as the digital television 4 of FIG. 1, which are designed to restore the content of data read by a reading device.

Of course, this separation between the three categories of devices is made for the requirements of simplifying the explanation and an actual consumer electronic apparatus may very well incorporate two categories of devices described hereinabove, or even three. For example, a digital television can also contain the device for reading the transmissions broadcast in digital form or a DVD reader may also contain a recording device.

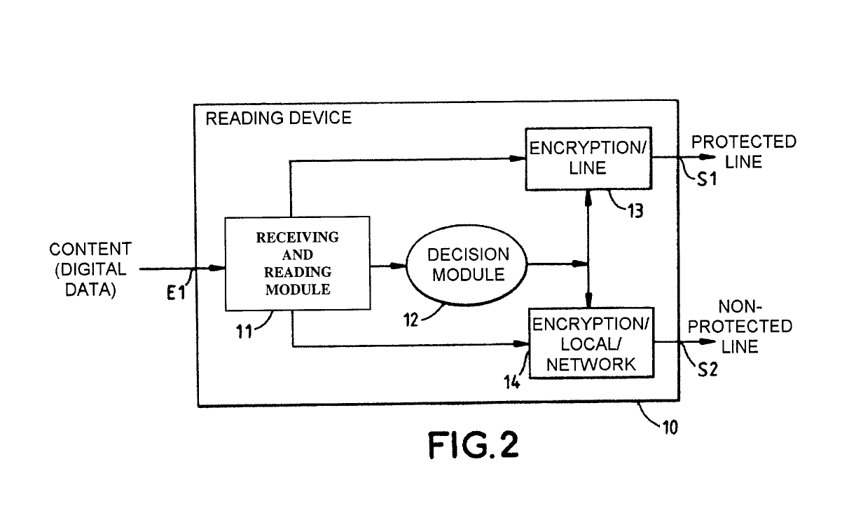

Represented in FIG. 2 is a reading device 10 according to the invention. On its input E1, this device receives digital data representing a content. This content may be a pre-recorded content, a content recorded in the network, a broadcast content or a downloaded content. The digital data are received by a receiving and reading module 11 which is capable of interpreting the format of the data received. In fact this module differs depending on the type of apparatus belonging to the first category. This module has functions dedicated according to the type of content which it receives: thus, if a reading device is a video DVD reader, the module 11 will recognize the format of data scrambled according to the CSS system (standing for “Content Scramble System”) customarily used to protect the content of DVD discs and will be capable of descrambling the data; if the reading device is a digital decoder, the module 11 will recognize the format of broadcast data streams protected by a conditional access system and will be capable of descrambling the data if the user possesses the necessary rights.

The reading device furthermore comprises a decision module 12 which performs a check to control the reading of the data, that is to say it determines whether the data read at input can be copied freely (“Copy-Free” status), can be copied once only (“Copy-Once” status), can no longer be copied (“Copy-No-More” status), can never be copied (“Copy-Never” status) or whether these data read represent an illegal copy and hence may not be restored on a restoring device. To determine these various statuses, the decision module uses a process which will be described later in conjunction with FIG. 5, on the basis, either of the whole of the data stream which it receives from the receiving and reading module 11, or of just certain information extracted from this data stream, depending on the type of carrying out chosen by the person skilled in the art.

At output it generates copy generation management information, for example information in the CGMS format (standing for “Copy Generation Management Status”), which is subsequently used by the recording or restoring devices to determine whether the data may be recorded or copied.

In practice, this information is transmitted to two output encryption modules 13 and 14 which, as a function of the copy generation management information received, supply the data respectively to the outputs S1 or S2 in protected or unprotected form, the information relating to the status of the data being also transmitted as output in the data stream.

If the copy generation management information indicates that the data read represent an illegal copy, the encryption modules 13 or 14 will not supply any data at output. It will thus not be possible to view the content, for example when dealing with a film, or to record it.

If this information indicates that the data have a “Copy-Free” status, that is to say that they can be copied freely, the data will be transmitted on one or other of the outputs S1 or S2 or on both without being encrypted.

On the other hand if this information indicates that the data have a “Copy-No-More” or “Copy-Never” or “Copy-Once” status, they will be transmitted to the outputs S1 or S2 in encrypted form.

According to the invention, the reading device comprises two different modules for output encryption. The outputs S1 and S2 of the device are digital outputs, that is to say that they are intended to be linked to a digital bus. On the other hand, they each use a different protection mode.

For the output S1, the data are protected at line level, for example according to the “DTCP” protection proposal in respect of a digital bus according to the IEEE 1394 Standard (“DTCP” is an acronym standing for “Digital Transmission Content Protection”, also known by the name “5C”, further details of which may be found in the publication “5C Digital Transmission Content Protection White Paper”, Rev. 1.0, Jul. 14, 1998, available at the following Internet address http://www.dtcp.com/). When this output is used, the data are encrypted by the encryption module 13 in a line specific manner.

For its part, the output S2 leads to a nonprotected line. In this case, the data are encrypted according to a local protection mode of the home network, in such a way that the content is protected. It will in particular be possible to use the local mode of encryption of the data in accordance with the XCA proposal (acronym standing for “extended Conditional Access”, further details of which may be found in the publication “XCA, A Global Copy Protection System for Home Networks, White Paper v. 1.2” published on Jan. 6, 2000). In the case where this output S2 is used, the data are encrypted by the local encryption module 14.

The outputs S1 and S2 of the reading device have been represented separately in FIG. 1 but in reality there may be a single output socket making it possible to plug the device into the bus B of the home network. In this case, the digital bus may comprise two distinct modes of operation: the protected mode in which the data are encrypted in respect of a specific link between two apparatuses of the network and the nonprotected mode in which the data are encrypted in a global manner at network level.

The choice of the type of output depends in fact on the apparatus intended to receive the data read by the reading device. Indeed, the reading device of the invention is intended to be able to be used in conjunction with other devices which support only a single mode of protection: either that at line level, or that at local network level. Between the device which receives the data and that which transmits them on the bus destined therefor, there is in a known manner an exchange during which the reading device knows the type of protection supported by the destination apparatus and can thus determine which output S1 or S2 will be chosen to transmit the data. If the apparatus intended to receive the data supports both modes of protection just like the reading device, the choice of the output S1 or S2 will be predetermined depending on the carrying out chosen by the person skilled in the art. It is also possible in this case to use both outputs, that is to say to transmit the data both on the protected line and on the nonprotected line, if these are physically separate.

In conjunction with FIG. 5, we shall now describe the process implemented by the decision module 12 to determine the status of the data for copy generation management.

The first test 100 consists in verifying whether the data received are encrypted. If such is not the case (output “N”), this signifies that one is dealing with a content which is a creation of the user or with a content which has been pirated. This is why an additional test 101 may be performed preferably but not compulsorily, to determine whether the content is watermarked. If the response is positive (output “Y”), this signifies that the content has been pirated and the reading device must refuse to read it (output “STOP!”). If on the other hand the content is not watermarked (output “N” in test 101), then the content is actually free to copy and the “Copy-Free” status is allocated to it.

If the response to the first test 100 is positive (output “Y”), that is to say if the data received are encrypted, the following test 102 consists in detecting the type of medium of the content. This applies in particular in respect of the detachable media such as DVDs which may be of the “Recordable” type (for example the DVD-RAM, DVD-RW, DVD-R formats) or of the “Nonrecordable” type (for example pre-recorded video DVD or DVD-ROM). The data broadcast or downloaded will by convention be of the “Nonrecordable” type.

If the medium of the content is of the “Recordable” type, the following test 103 consists in detecting whether the supplier of the content has given the right to perform a single copy (“Copy-Once” status) or no copy (“Copy-Never” status) of its content. This copy control information commonly denoted by the acronym CCI (the acronym standing for “Copy Control Information”) or CGMS (the acronym standing for “Copy Generation Management System”) is present in the data in a form determined by the supplier of the content and which is well known to the person skilled in the art. If a medium of the “Recordable” type has a “Copy-Once” status, this signifies that the medium is itself the only copy and that copying can no longer be authorized. Consequently the output status will be “Copy-No-More”. On the other hand, if the latter has a “Copy-Never” status, this signifies that this is a pirate copy and the latter may not be read by the reading device (“STOP!” output).

It should be noted that the “Copy-No-More” status signifies that it is prohibited to perform an additional generation of copy of the data received. This status signifies also, in the case where we have a local protection at network level (for example according to the XCA proposal), that it is possible to make a local copy of the data, this data not being readable by any other device except for those of the network in which this copy was made, or stated otherwise that it is not possible to perform an additional generation of copy in respect of another home network.

If the medium of the content is of a “Nonrecordable” type or if the data received are data broadcast or downloaded, the same test as the test 103 is performed (test 104) and the status detected (“Copy-Once” or “Copy-Never”) corresponds to the output status allocated to the data.

The “Copy-Once” status also authorizes the local copying at home network level when we have a protection mode local to the network.

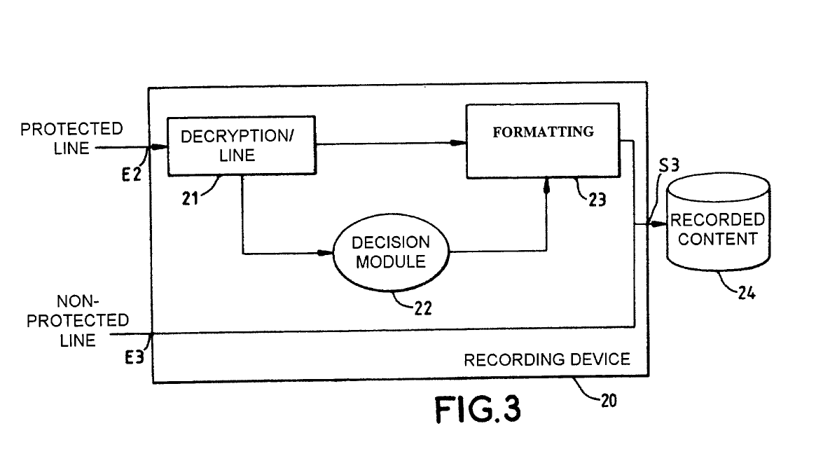

We shall now describe a recording device 20 according to the invention, as represented diagrammatically in FIG. 3.

This device comprises two digital inputs E2 and E3, the first E2 receiving the data via a protected line and the second E3 via a nonprotected line. As was seen earlier, this may in reality involve a single physical connection with a digital bus capable of operating in a “protected” mode or in a “nonprotected” mode. The choice of the input depends on the type of apparatus with which the recording device is linked and on the protection modes supported by this apparatus.

In the case where the data are received on the input E2, they are transmitted to a decryption module 21 which performs a decryption by using a specific key of the line, which has for example been exchanged with the reading device which sent the data on the line.

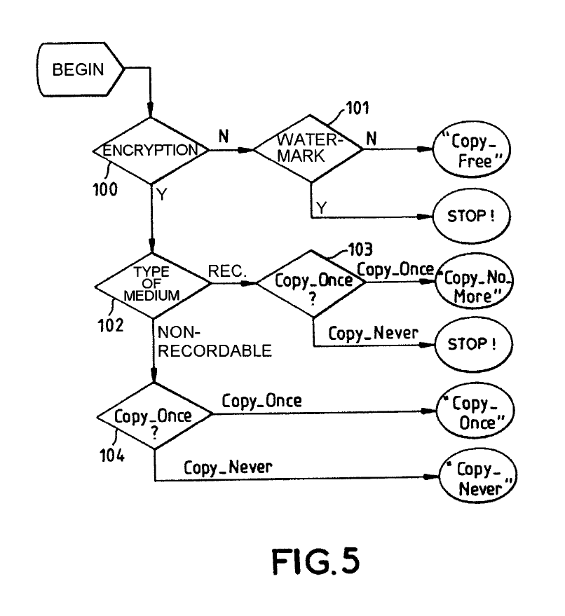

The information relating to the status of the data, that is to say the copy generation management information for the data, is extracted from the data stream and analysed by a decision module 22 according to the process which will be described in conjunction with FIG. 6 hereinbelow. This process performs a check to control the copy at the level of the recording device.

If the status detected is of the “Copy-No-More” or “Copy-Never”, type, recording is stopped and the decision module 22 gives the instruction to a formatting module 23 not to transmit any data as output for the recording.

If on the other hand the status detected is of the “Copy-Once” type, the decision module 22 gives the instruction to the module 23 to perform a formatting for the recording in such a way that the data are not recorded as plaintext. This may for example involve an encryption according to the CPRM proposal (the acronym standing for “Content Protection for Recordable Media” further details of which may be found at the following Internet address: http://www.4centity.com/4centity/tech/cprm/). The formatted data are subsequently transmitted at output S3 so as to be stored on a recording medium 24.

When the status detected by the decision module 22 is of the “CopyFree” type, the recording of the data can be performed as plaintext, that is to say without the data being formatted by the module 23.

In the case where the data are received on the input E3, they are already protected by a local encryption at network level. In this case, the recording device does not perform any processing and merely records the data in encrypted form.

In conjunction with FIG. 6, we shall now describe the process implemented in the decision module 22 of the recording device.

The module 22 has two sources of information for ascertaining the status of the data with regard to the management of the copy generations: the information defined by the system for protection at line level—this information being analysed in step 110—and the information integrated into the actual content of the data transmitted on the nonprotected line—information analysed in step 111. In principle, the two sources should supply the same data statuses but, preferably, and to improve the security of the system, an additional test 112 is performed to define the most restrictive status among the information received.

The order of restriction among the statuses is as follows:

“Copy-Never”=“Copy-No-More”>“Copy-Once”>“Copy-Free”;

“>” signifying “is more restrictive than”.

For example, if an item of information analysed in step 110 indicates a “Copy-Once” status while the item analysed in step 111 indicates a “CopyFree” status, the status retained in step 112 will be “Copy-Once”.

Next, depending on the status defined in step 112, the decision module 22 of the recording device will authorize recording (“Copy-Free” or “Copy-Once” statuses) or will not authorize recording (“Copy-No-More” or “Copy-Never” statuses).

It should be noted that it will always be possible to record the data received on the nonprotected line since these data already benefit from protection specific to the local network, that is to say that they are encrypted in such a way that they can be read (and restored) only by an apparatus of the network.

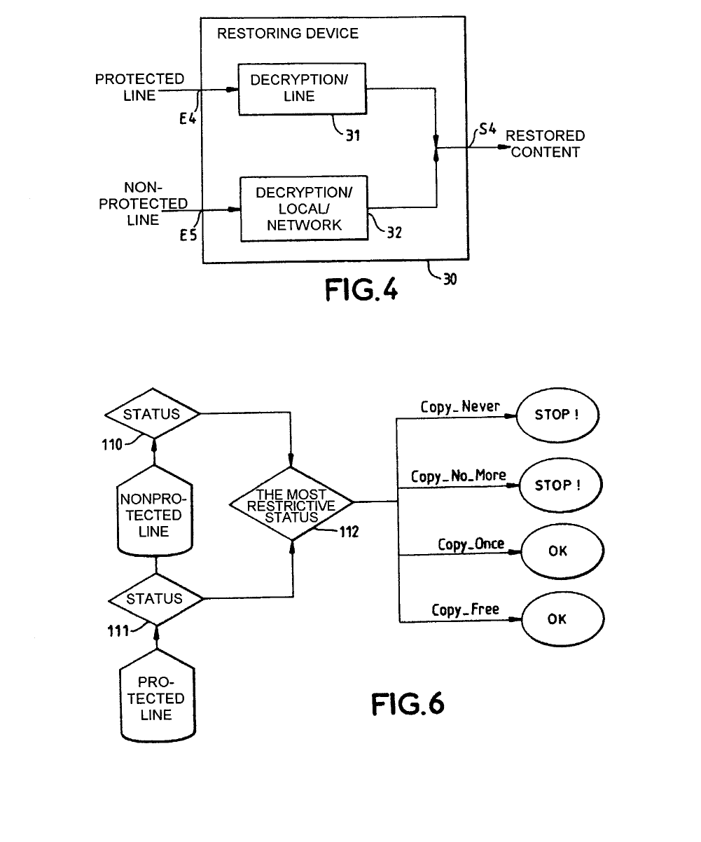

We shall now describe a data restoration device 30 according to the invention, as represented in FIG. 4.

This device comprises, like the recording device 20, two digital inputs E4 and E5, linked respectively to a protected line and to a nonprotected line. When the data are received on the input E4, they are decrypted by the decryption module 31 specific to the line. They are subsequently transmitted at output S4 so as to be restored. For example, when dealing with a digital television, the data are transmitted to the display means (cathode ray tube, plasma screen, etc.) for viewing.

When the data are received on the input E5, they are transmitted to a local decryption module 32 specific to the network in which the device is located. This module constitutes the conclusion of the “end-to-end” protection of the network since the data are decrypted, in this protection mode, only for restoral at the output S4 of the device.

The reading, recording and restoring devices of the invention are thus compatible with the various existing protection modes in digital home networks and thus allow better interoperability of systems for protection against illicit copying.

It should be noted that the term “line” as employed throughout the description extends to any communication channel in a digital network, whether this channel consists of a physical line or of a so-called “wireless” communication path.

1. Device for reading digital data (1, 2, 10) which is intended to be connected to a digital home network and is capable of receiving data representing a content, characterized in that it comprises:
a first means (13) for encrypting the data according to protection mode specific to a line with which the device is intended to be connected to another device of the digital network, the encrypted data being in this case supplied to a first output (S1); and
a second means (14) for encrypting the data according to protection mode specific to the home network, the encrypted data being in this case supplied to a second output (S2).

2. Device according to claim 1, characterized in that it further comprises a decision module (12) adapted for delivering a permission or a prohibition to copy and/or to read said digital data,
said digital data being supplied to the first (13) or the second (14) means for encrypting when said decision module (12) delivers a copy prohibition (“Copy-Never”; “Copy-No-More”) or a single-copy permission (“Copy-Once”).

3. Device according to claim 2, characterized in that said digital data are supplied directly to the first (S1) and/or to the second (S2) output without being encrypted when said decision module (12) delivers an unlimited copy permission (“Copy-Free”).

4. Device according to one of claims 2 or 3, characterized in that it does not supply any digital data to the first (S1) or to the second (S2) output when said decision module (12) delivers a read prohibition (“STOP!”).

5. Device according to one of claims 2 to 4, characterized in that said decision module (12) delivers an unlimited copy permission (“Copy-Free”) when said digital data received are not encrypted.

6. Device according to claim 5, characterized in that said decision module (12) delivers an unlimited copy permission (“Copy-Free”) when moreover said digital data received are not watermarked.

7. Device according to one of claims 2 to 4, characterized in that said decision module (12) delivers a read prohibition (“STOP!”) when:
said digital data received are not encrypted; and
said digital data received are watermarked.

8. Device according to one of claims 2 to 4, characterized in that said decision module (12) delivers a copy prohibition (“Copy-No-More”) when
said digital data received are encrypted; and
said digital data received are stored on a medium of recordable type; and
copy control information contained in said data indicate that a single copy is authorized.

9. Device according to one of claims 2 to 4, characterized in that said decision module (12) delivers a read prohibition (“STOP!”) when:
said digital data received are encrypted; and
said digital data received are stored on a medium of recordable type; and
copy control information contained in said data indicate that no copy is authorized.

10. Device according to one of claims 2 to 4, characterized in that said decision module (12) delivers a single-copy permission (“Copy-Once”) when:
said digital data received are encrypted; and
said digital data received are stored on a medium of nonrecordable type or are data broadcast or downloaded; and
copy control information contained in said data indicate that a single copy is authorized.

11. Device according to one of claims 2 to 4, characterized in that said decision module (12) delivers a copy prohibition (“Copy-Never”) when:
said digital data received are encrypted; and
said digital data received are stored on a medium of nonrecordable type or are data broadcast or downloaded; and
copy control information contained in said data indicate that no copy is authorized.

12. Device according to one of the preceding claims, characterized in that the information regarding permission or prohibition to copy and/or to read the said digital data delivered by the decision module (12) is attached to the data supplied to the first (S1) or to the second (S2) output.

13. Device according to one of the preceding claims, characterized in that the first (S1) and the second (S2) output are linked respectively to a single plug for connecting said device to a digital bus (B) of the home network, said bus operating in a first protected mode when the data emanate from the first output (S1) and in a second nonprotected mode when the data emanate from the second output (S2).

14. Device according to one of the preceding claims, characterized in that the choice of the first (S1) or of the second (S2) output to supply the data is determined by the device connected to the digital home network intended to receive the data transmitted by said reading device on the home network.

15. Device for recording digital data (3, 20) which is intended to be connected to a reading device (1, 2, 10) according to one of claims 1 to 14 by way of a digital home network, characterized in that it comprises:
a first input (E2) intended for receiving data which have been supplied to the first output (S1) of said reading device (10); and
a second input (E3) intended for receiving data which have been supplied to the second output (S2) of said reading device (10).

16. Device according to claim 15, characterized in that it comprises a means (21) for decrypting the data according to protection mode specific to a line with which the device is intended to be connected to the reading device, said means (21) for decrypting being linked to the first input (E2) of said recording device.

17. Device according to one of claims 15 or 16, taken in their dependence on claim 12, characterized in that it furthermore comprises a decision module (22) adapted for analysing the copy and/or read permission or prohibition information attached to the data to be recorded,
said recording device delivering the data to be recorded to an output (S3) when said decision module (22) detects a copy permission (“Copy-Once”; “Copy-free”)
said recording device delivering no data item to be recorded to the output (S3) when said decision module (22) detects a copy prohibition (“CopyNo-More”; “Copy-Never”).

18. Device for restoring digital data (4, 30) which is intended to be connected to a reading device (1, 2, 10) according to one of claims 1 to 14 by way of a digital home network, characterized in that it comprises:
a first input (E4) intended to receive data which have been supplied to the first output (S1) of said reading device (10) and which is linked to a first means (31) for decrypting the data according to a protection mode specific to a line with which the device is intended to be connected to the reading device;
a second input (E5) intended to receive data which have been supplied to the second output (S2) of said reading device (10) and which is linked to a second means (32) for decrypting the data according to a protection mode specific to the home network; and
an output (S4) for the restoring of the data, which is linked to the first and the second means for decrypting.
